(19) United States
(12) Patent Application Publication
(10) Pub. No.: US 2018/0304531 A1
(43) Pub. Date: Oct. 25, 2018

(54) SYSTEMS AND METHODS OF MANIPULATING POLYMERS

(71) Applicants: Nathan Daniel Gallant, Tampa, FL (US); Kyle Joseph Hunter, Seminole, FL (US)

(72) Inventors: Nathan Daniel Gallant, Tampa, FL (US); Kyle Joseph Hunter, Seminole, FL (US)

(73) Assignee: UNIVERSITY OF SOUTH FLORIDA, Tampa, FL (US)

(21) Appl. No.: 15/912,339

(22) Filed: Mar. 5, 2018

Related U.S. Application Data
(60) Provisional application No. 62/466,597, filed on Mar. 3, 2017.

(51) Int. Cl. B29C 64/209; B33Y 10/00; B33Y 30/00; B33Y 40/00; B33Y 50/02; B29C 64/106; B29C 64/393; B33Y 70/00

(52) U.S. Cl. CPC B29C 64/209; B33Y 10/00; B33Y 30/00; B33Y 70/00; B33Y 50/02; B29C 64/106; B29C 64/393; B33Y 40/00

(57) ABSTRACT

Methods and systems are provided for mixing component materials and dispensing a gradient product comprising a continuously varied composition of matter. The method includes delivering, by multiple dispensing devices actuated by a motor, component material to a connector where each of multiple connector inputs receives component material from a respective one of the multiple dispensing devices. The component material is forwarded to a mixing tube connected to a single output of the connector. The mixing tube receives the component material from each of the multiple dispensing devices via the connector and mixes the component material. A dispensing nozzle connected to the mixing tube, receives a continuously varying mixture of materials from the mixing tube and dispenses the continuously varying mixture of materials onto a collection bed to form a gradient product comprising a continuously varying composition of matter. An electronic processor controls the varied composition of matter of the gradient product.

### CROSS-REFERENCE TO RELATED APPLICATION(S)

This application claims priority to U.S. Provisional Patent Application No. 62/466,597, filed Mar. 3, 2017, the entire contents of which are hereby incorporated by reference in its entirety.

### STATEMENT REGARDING FEDERALLY SPONSORED RESEARCH OR DEVELOPMENT

This invention was made with government support 1551309 awarded by the National Science Foundation. The Government has certain rights in the invention.

### TECHNICAL FIELD

The invention relates to systems and methods for creating gradients products of multiple continuously varying material components.

### BACKGROUND

Gradient materials have a promising future in engineering manufacturing and in biomedical engineering. Since the early days of modern manufacturing efforts have been made to explore and utilize a variety of material properties. This has become more important recently with the development of more advanced and exotic composites like carbon fiber, graphite, or even more recently graphene. Often the goal is to make these materials lighter, stronger, tougher, or to find more efficient ways to make the materials, or making them at a lower cost.

The 3D printing industry that has grown rapidly in recent years. High-end and high-tech printers can now print in high strength materials, for example, advanced nylons. Such systems can produce parts that are nearly as strong as full production parts. This technology is significant in that a part can be quickly designed using computer software, and within minutes or hours, a full strength near production-ready prototype can be produced, which can then be tested.

3D printing is an additive process, which in this regard, is similar to bioprinting. It may start without any material and build its way outward. Unlike 3D printing that uses structural materials (typically plastics) a bioprinter uses a gel based substrate. This substrate is infused with cells and proteins and is laid down layer by layer to create living tissues. Bioprinting is still in its infancy but the hope is that one day bioprinters will be able to print a living organ. This organ could then be transplanted into a patient, alleviating issues with current organ transplantation.

Materials and manufacturing methods are advancing daily. However, manufactured parts often have a single material property throughout the entire part. When dissimilar materials are attached at a single discrete point, stress tensors are formed, and may indicate a greater likelihood that the part will fail at that point. For example, in a prosthetic limb, a top section may be made of a lightweight and very stiff carbon fiber that attaches to a rotational metal knee joint. The knee joint may attach to a flexible and strong titanium foot that allows for shock absorption. This configuration is used in high performance running prosthetics for athletes. Since these materials are quite different, and they are attached at a single point, the prosthetic limb must be overbuilt to endure applied stresses. Such manufactured products suffer by not having continuously changing material properties that occur in nature, for example, in transitions from soft muscle to tendon to cartilage to bone. Another example from nature includes the beak of a Humboldt squid that is made of one of the stiffest and strongest known materials. However, the stiff beak of the squid is attached to its soft body by varying the concentration water, proteins, and a biological polymer called chitin. The base of the beak is nearly 100 times softer than the tip. This allows the squid to have a strong beak for hunting that is also soft enough to attach to their body.

### SUMMARY

Methods and systems are provided, which allow for the creation of complex gradients of multiple polymer or liquid components, for example, a polymer, an ink, or a gel. The gradients may comprise a continuously varying composition of matter. These systems are controlled by a custom software back-end which allows for precise control of the concentrations being pumped by any system. An output mixture that varies in time and/or space along the pumping direction is collected by a synchronized moving stage to preserve the varied properties. Other aspects of the invention will become apparent by consideration of the detailed description and accompanying drawings.

In some embodiments, a system for mixing component materials and dispensing a gradient product comprising a continuously varied composition of matter includes multiple dispensing devices that are actuated by a motor. A connector comprising multiple inputs receives at each input component material from a respective one of the multiple dispensing devices. A mixing tube connected to an output of the connector receives the component material from each of the multiple dispensing devices and mixes the component material. A nozzle connected to the mixing tube receives a continuously varying mixture of materials from the mixing tube and dispenses the continuously varying mixture of materials to form a gradient product comprising a continuously varying composition of matter. A bed receives the gradient product. An electronic processor coupled to a memory comprising instructions that when executed by the electronic processor causes the electronic processor to spatially control the varied composition of matter of the gradient product.

In some embodiments, include a method for mixing component materials and dispensing a gradient product comprising a continuously varied composition of matter. The method includes delivering, by multiple dispensing devices actuated by a motor, component material to a connector comprising multiple inputs, wherein each of the multiple connector inputs receives the component material from a respective one of the multiple dispensing devices. The component material is forwarded to a mixing tube connected to a single output of the connector. The mixing tube receives the component material from each of the multiple dispensing devices via the connector and mixes the component material. A nozzle connected to the mixing tube, receives a continuously varying mixture of materials from the mixing tube and dispensing the continuously varying mixture of materials onto a bed to form a gradient product comprising a continuously varying composition of matter. An electronic processor controls the varied composition of matter of the gradient product.

Other aspects of the invention will become apparent by consideration of the detailed description and accompanying drawings.

### BRIEF DESCRIPTION OF THE DRAWINGS

FIGS. 1 and 2 illustrate a system for mixing materials to form an object having a gradient of composition or attributes, according to some embodiments.

FIG. 3 is an illustration of a graphical user interface (GUI) for fabricating a gradient according to several embodiments.

FIG. 4A is a plot of absorbance vs fraction red polymer along slide (1.8″ mixing tube, two mixers) where the number of samples used is six, according to some embodiments.

FIG. 4B is a plot of absorbance vs fraction red polymer along slide (3.8″ mixing tube, one mixer) where the number of samples used is six, according to some embodiments.

FIG. 4C is a plot of absorbance vs fraction red polymer along slide (1.8″ mixing tube, one mixer) where the number of samples used is six, according to some embodiments.

FIG. 4D is a plot of absorbance vs fraction red polymer along slide (3.8″ mixing tube, two mixers) where the number of samples used is two, according to some embodiments

FIG. 4E is a plot of elastic modulus vs distance along slide, the number of samples used is four, according to some embodiments.

FIGS. 5A-5C illustrate a system for mixing materials to form an object having a gradient in composition and/or physical attributes, according to some embodiments.

FIGS. 6A-6B illustrate a system for mixing materials to form an object having a gradient in composition and/or physical attributes, according to some embodiments.

### DETAILED DESCRIPTION

One or more embodiments are described and illustrated in the following description and accompanying drawings. These embodiments are not limited to the specific details provided herein and may be modified in various ways. Furthermore, other embodiments may exist that are not described herein. Also, the functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way, but may also be configured in ways that are not listed. Furthermore, some embodiments described herein may include one or more electronic processors configured to perform the described functionality by executing instructions stored in non-transitory, computer-readable medium. Similarly, embodiments described herein may be implemented as non-transitory, computer-readable medium storing instructions executable by one or more electronic processors to perform the described functionality.

In addition, the phraseology and terminology used herein is for the purpose of description and should not be regarded as limiting. For example, the use of “including,” “containing,” “comprising,” “having,” and variations thereof herein is meant to encompass the items listed thereafter and equivalents thereof as well as additional items. The terms “connected” and “coupled” are used broadly and encompass both direct and indirect connecting and coupling. Further, “connected” and “coupled” are not restricted to physical or mechanical connections or couplings and can include electrical connections or couplings, whether direct or indirect. In addition, electronic communications and notifications may be performed using wired connections, wireless connections, or a combination thereof and may be transmitted directly or through one or more intermediary devices over various types of networks, communication channels, and connections. Moreover, relational terms such as first and second, top and bottom, and the like may be used herein solely to distinguish one entity or action from another entity or action without necessarily requiring or implying any actual such relationship or order between such entities or actions.

It should also be noted that a plurality of hardware and software based devices, as well as a plurality of different structural components may be used to implement the embodiments set forth herein. In addition, it should be understood that embodiments may include hardware, software, and electronic components that, for purposes of discussion, may be illustrated and described as if the majority of the components were implemented solely in hardware. However, one of ordinary skill in the art, and based on a reading of this detailed description, would recognize that, in at least one embodiment, the electronic-based aspects of the embodiments may be implemented in software (e.g., stored on non-transitory computer-readable medium) executable by one or more electronic processors.

Methods and systems are provided, which allow for the creation of complex gradients of multiple polymer or liquid components. The systems are controlled by a custom software back-end which allows for precise control of the concentrations being pumped by any system. An output mixture that varies in time and/or space along the pumping direction is collected by a synchronized moving stage to preserve the varied properties.

One embodiment includes two separate, commercially available dispensing devices and a laser cut linear actuator. The system may be controlled by a custom programming back-end, which synchronizes the rate of polymer being dispensed from each dispensing device and the rate of the linear actuator movement. More than two pumps may be controlled similarly, and the dispensing devices can be replaced by custom built pumps, removing any dependence on a commercial product. Once the polymer is dispensed from the pumps, it is blended by thorough mixing. The result is a polymer mixture that is homogenous in the cross section, but which can be varied along the pumping direction. Thus, the output mixture is dispensed through an exit nozzle with properties that vary with the programmed mixture. Finally, this output is collected on a build tray moving on the linear actuator so that the spatial variation is captured in the final product.

The programming interface controls the rates of both dispensing devices separately, enabling the concentration of the dispensed polymer mixture to be controlled. This allows for the creation of linear gradients or more complex concentration and/or composition functions. Using a mass spectrometer plate reader, the accuracy of the linear gradients created by the system may be characterized. Also, functional linear material gradients of varying stiffness have been created.

Some aspects of this system include a broad range of applications and devices that the programming back-end can be used with. Complex algebraic code of the programming back-end allows this same program code to control any type of pump that is enabled for varying of rates. Some embodiments of the present disclosure are applicable in the field of biomaterials and 3D printing. For example, the present system is able to control the concentration of cells laid down in a biological printing process. Furthermore, the present system can be utilized to create 3D printing feedstock filaments of varying properties, enabling 3D printed parts of continuously changing material properties (stiffness, toughness, hardness, etc.).

Functional polymer gradients, those of varying surface or chemical properties such as stiffness or wettability are useful both as a test bed and a final product. However, it would be easier and more efficient to test a single, continuously changing polymer, than to test multiple discrete samples with differing properties. One example includes testing cellular adhesion on a polymer with varying stiffness or wettability. Using a known gradient, the polymer composition of greatest cellular activity can be determined.

Gradient property materials may also find important applications in manufacturing in many sectors. This disclosure provides the capability to fabricate, through a single-step additive process, parts with continuously varied properties. Examples include bi- or multi-stable mechanisms, parts with sacrificial or removable layers, gradient engineered tissues, and composite materials. However, the disclosure is not limited to these specific examples.

The commonly researched methods for creating gradients consist of using a single polymer specific method that is limited to adjusting surface properties. Those methods only work with one specific surface characteristic on a specific type of polymer. However, with the present methods and systems, any property that can be changed chemically can be varied in a gradient. Moreover, components such as nanoparticles or cells can be embedded into the polymer matrix, creating a system with varied concentrations of additives that augment the properties.

Mixing Different Polymer Samples

There has been much emphasis on the use of polymers with various types of chemical properties in material science. Producing polymers with a continuously changing attribute is useful both as a test bed and for real world applications. An efficient way of manipulating a polymer is by creating a continuously changing gradient. The gradient can be tested along its length for determining a desired concentration or attribute. This avoids making separate discrete samples and testing each individually. The present disclosure provides a system that allows for the continuous changing of any possible material attribute along a surface. This system has been tested and the results characterized to show an amount of error present.

One of the most commonly studied physical properties in biomaterial science is the effect of matrix stiffness on cellular activity. It has been shown that cell migration of some cell types tends to occur more rapidly and efficiently in soft gels as compared with stiffer gels. Depending on the stiffness of the matrix in which cells are located, the morphology of the cells can change by increasing or decreasing in length. Results have shown that stem cells proliferate more frequently in a softer gel. Another interesting result is that 3T3 fibroblasts tend to travel along a gradient of increasing stiffness. This allows the controlled directional migration of cells by changing the stiffness gradient of a matrix.

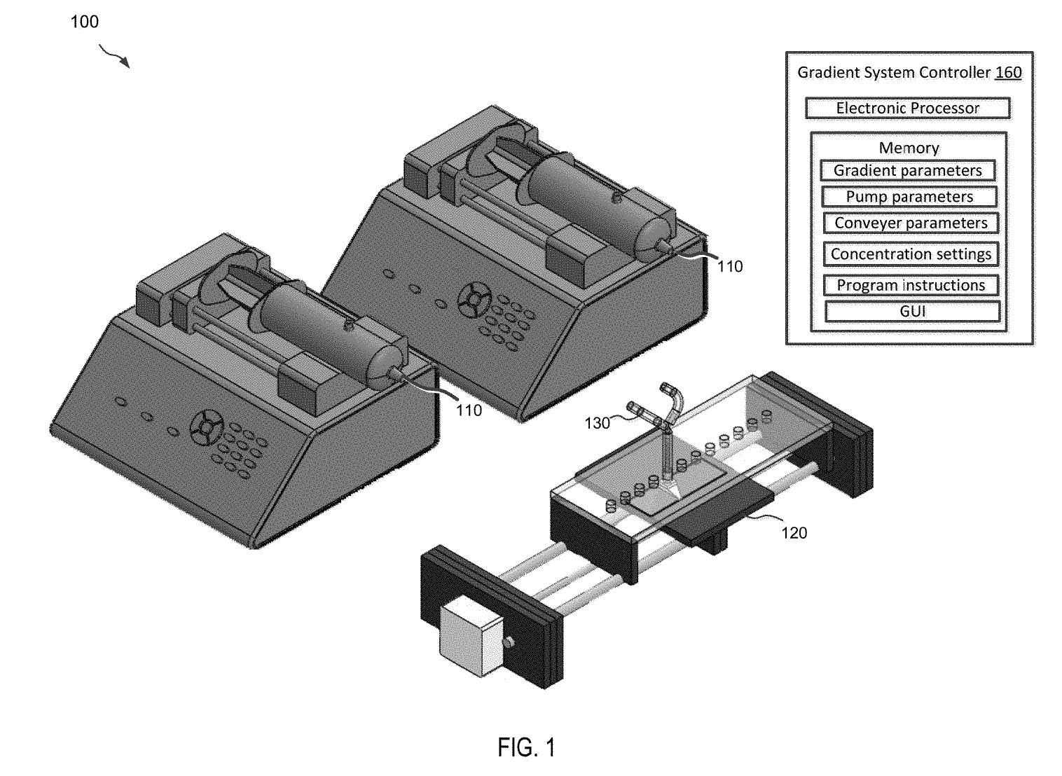

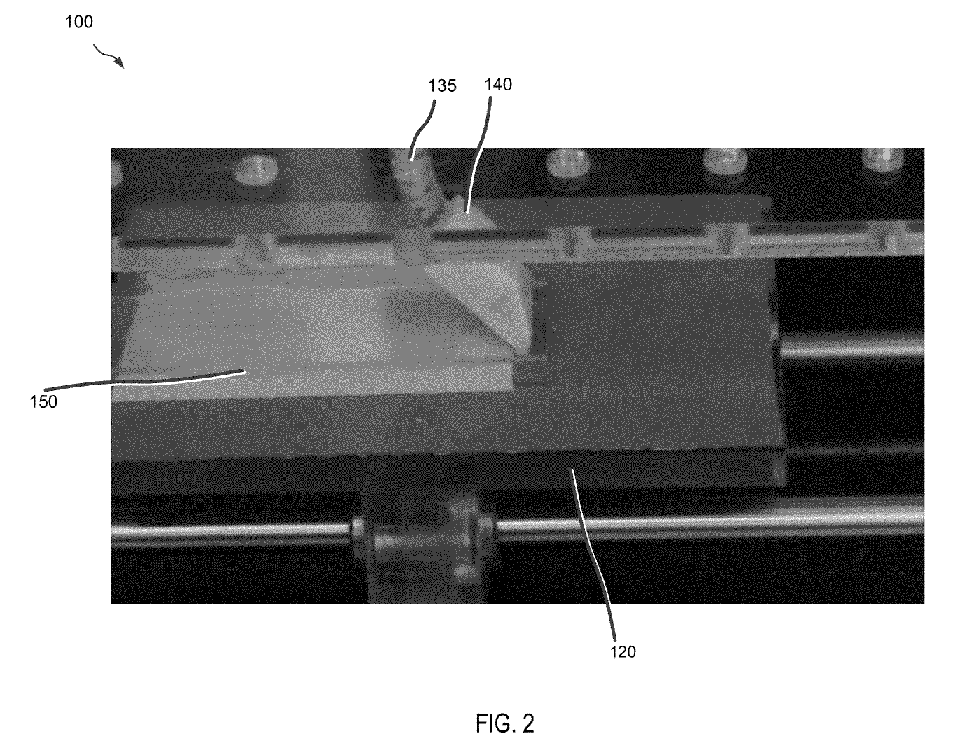

FIGS. 1 and 2 illustrate a system for mixing materials to form an object having a gradient of composition or attributes, according to some embodiments. Referring to FIGS. 1 and 2, a system 100 includes two dispensing devices 110 and a linear actuator 120. In some embodiments, a dispensing device 110 may comprise a syringe pump where a syringe is placed in the syringe pump. However, the disclosure is not limited in this regard and any suitable dispensing device 110 may be utilized. For example, there are many ways in which solutions can be pumped. Outputs of each of the two dispensing devices 110 are attached to a respective section of tubing (not shown). Each of the two sections of tubing is connected to one of two inputs of an Omega Y connector 130 so that a material, for example, a polymer can flow from each the outputs of the two dispensing devices 110 into the two inputs of the Omega Y connector 130. The Omega Y connector 130 is supported above the linear actuator 120. Another single piece of tubing forms a mixing tube 135 that is connected to a single output of the Omega Y connector. Inside the length of the mixing tube 135, one or two Omega static mixer(s) is/are inserted (not shown). The mixing tube 135 is further attached to a nozzle 140 (see FIG. 2), for example, an Acrylonitrile butadiene styrene (ABS) 3D printed nozzle. The end of the nozzle 140 may be placed in a holding tray above a slide 150, for example, a glass slide (See FIG. 2). The slide 150 is disposed on the linear actuator 120 for carriage of the slide 150 by the linear actuator 120. A gradient system controller 160 is communicatively coupled to each of the two dispensing devices 110 and to a stepper motor (not shown) of the linear actuator 120. The controller 160 comprises an electronic processor and memory. The memory stores program instructions that cause the electronic processor to send commands to the two dispensing devices 110 110 to dispense polymer from the two dispensing devices 110 to form a gradient. The program instructions provide constant ratio or complex function inputs to control time-dependent dispensing device dispense rates for each of the dispensing devices 110 for creating a specified gradient. The program instructions further cause the electronic processor to send commands to the linear actuator 120 to move the slide at a specified speed such that the nozzle 140 dispenses the specified gradient on the slide 150.

The system 100 physically mixes two different polymer samples output by the two dispensing devices 110 and then dispenses them on the slide 150 via the nozzle 140. This system and method makes it possible to vary any property that is affected by changing material compositions.

In some embodiments, the materials that are loaded into the dispensing devices 110 to form the gradient may comprise a polydimethylsiloxane (PDMS) compound. PDMS is a silicone-based polymer. When PDMS is cured the stiffness of the material is directly related to how much crosslinker is included. An increased concentration of crosslinker will cure to an increased stiffness.

Any specified concentrations of the polymers may be utilized. For example, a high concentration of crosslinker to PDMS ratio may be used in a first one of the dispensing devices 110 to create a stiff material, and a low concentration of crosslinker to PDMS ratio may be used in the other dispensing device 110. However, the program instructions of controller 160 may create any prescribed concentration gradient along the slide 150. In one embodiment, a linear gradient may be created that goes from being soft at one end of the slide to being stiff at the other end. In this example, when the soft polymer is dyed red and the stiff polymer is clear, the resulting gradient may begin substantially clear (stiff) at one end and transition to completely red (soft) at the other end. A deflection gauge may be used to map the elastic modulus throughout the entire length of the gradient on the slide 150. The mapped elastic modulus may have a linear relationship from one end of the slide 150 to the other. However, the system 100 is not limited to creating linear gradients, and any type of function may be utilized to form a gradient along this slide 150.

When designing and testing a system 100 and the software instructions that interface with it to control the gradient, an error in the resulting gradient was found to decrease when the range of varied concentrations also decreased. This error was the amount the linear gradient differed from the ideally formed linear gradient determined from the discrete samples created. Also, an amount of error was found to be directly related to an amount of surface area in contact with the polymer in the mixing tube section 135. The shorter the tube and mixing element resulted in smaller error. To determine the accuracy of the system 100, gradients produced by the system were characterized and compared to discrete samples.

Once the system 100 was characterized and the amount of error was deemed acceptable, gradients were created with a varying functional property. One property that was varied was the stiffness of a PDMS compound. This variation was created using two separate dispensing devices 110 with different ratios of base PDMS to curing agent. One dispensing devices 110 was loaded with a 50:1 ratio and the other with a 10:1 ratio. The elastic modulus was then calculated using the values of deflection obtained from a macroscale deflection gauge. The elastic modulus was then compared with other reported values from discrete samples.

Custom Gradient Fabrication Device

In one embodiment, the gradient system controller 160 comprised a raspberry Pi B+ that interfaced with all hardware including the dispensing devices 110 and the linear actuator 120. The use of the Pi B+ allowed the system to be used in a standalone configuration, without the need for any additional equipment. A linear actuator 120 was built using ¼″ clear acrylic sheets and a NEMA 17 stepper motor built by Adafruit Industries. This actuator 120 moved a sliding tray holding a microscope slide 150 that the polymer was dispensed on. The stepper motor was driven by an Adafruit TB6612 stepper motor driver.

Python 3 language was used for programming the Pi B+ using the NUMPY scientific library, as a gradient controller 160. This allowed the code to be easily written and was fast upon execution. Both a command line interface and a graphical user interface (GUI) was written for ease of use. The linear actuator stepper motor was soldered directly to the Pi's general purpose input output pins (GPIO). For the two dispensing devices 110, two New Era Pump Systems NE-1000 syringe pumps were used to dispense the gradient. The pumps were controlled using serial commands from the USB Bus connected to the Pi B+ controller 160. The custom software allowed for constant ratio or complex function inputs to control the time-dependent dispensing device dispense rates.

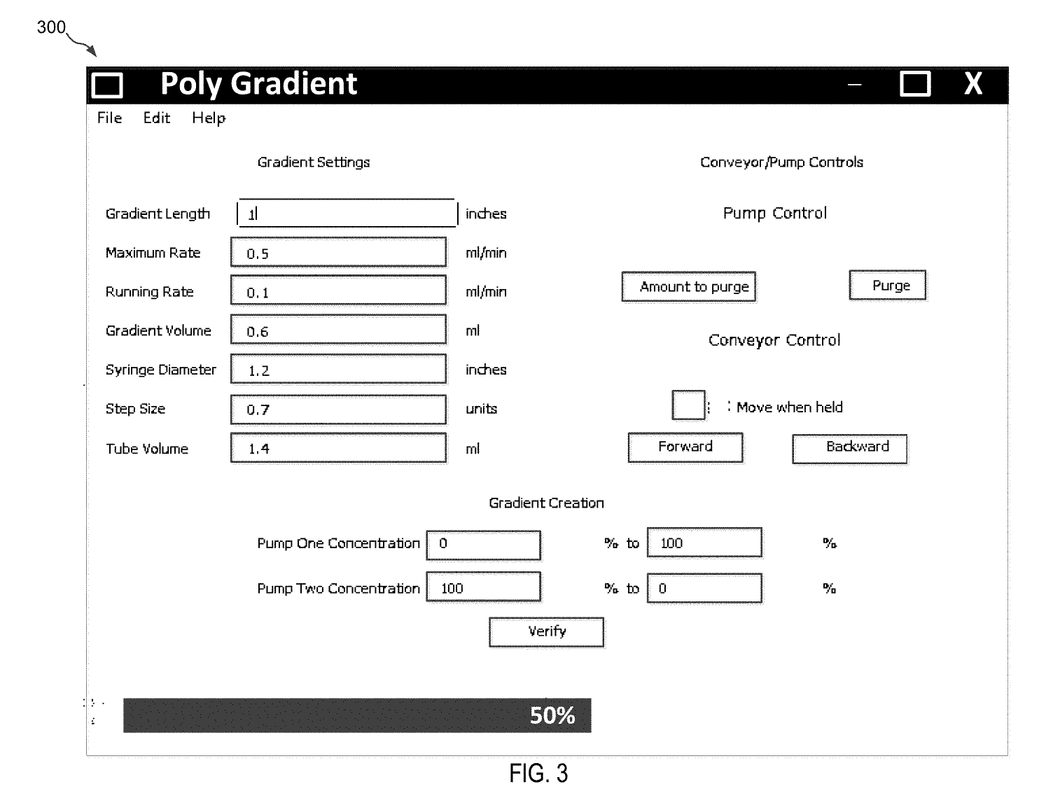

FIG. 3 is an illustration of a graphical user interface (GUI) for fabricating a gradient according to several embodiments. Referring to FIG. 3, a GUI 300 includes elements for entering gradient settings, for example, a gradient length, a maximum rate, a running rate, a gradient volume, a dispensing device diameter, a step size, and a tube volume, to control the fabrication of a specified gradient. Dispensing device control elements may include, for example, an amount to purge and purge control, to control the fabrication of a gradient. Linear actuator conveyor control elements may include, for example, forward, backward and move when held, to control the fabrication of a specified gradient. Gradient creation elements may include dispensing device 1 base material concentration, and dispensing device 2 base material concentration. The GUI 300 may be modified for systems comprising more than two dispensing devices or other types of material delivery components. In some embodiments, the GUI may be generated by the gradient controller system 160 and displayed on a monitor for receiving user input to control the fabrication of a gradient by the dispensing devices 110 and the linear actuator 120. Alternatively, the GUI 300 may be generated by another computer system (not shown) and user input may be sent to the gradient controller 160 to configure the controller to generate a specified gradient.

Gradient Setup

In one embodiment, a PDMS polymer was Sylgard 184 base and a curing agent manufactured by Dow Corning. The sample in one of the dispensing devices was dyed red to measure the absorbance to quantify the composition. The dye was red silicone pigment (Silc Pig) manufactured by Smooth-On. The sample that was dyed was mixed at a rate of 1 mg per 4.365 g of base and curing agent of Sylgard 184. This ratio was concentrated enough to allow a significant difference between it and the clear material, without oversaturating the absorbance detector when mixed. Both samples were mixed thoroughly and then degassed using a vacuum pump.

System Setup

Once the clear and red polymer samples were degassed fully they were drawn into 10 mL BD syringes and placed in the syringe pumps. A 6-inch piece of Cole-Parmer 0.25″ diameter clear tubing was attached to each dispensing devices 110 and connected to an Omega Y connector 130. A single piece of tubing was then attached to the single output of the Omega Y connector. Inside this length of tubing from the output of the Omega Y connector, one or two Omega static mixer(s) was(were) inserted inside. The tubing was then attached to an Acrylonitrile butadiene styrene (ABS) 3D printed nozzle. The length of the mixing tube, and the number of mixers used were varied throughout the tests.

Gradient Creation

The end of a nozzle 140 was placed in the acrylic holding tray above the linear actuator 120 moving slide 150. When the proper settings were determined in the python code the system began running. The settings included the start and end concentration of the gradient, total polymer volume, running rate, and volume of the mixing tube. The system would first purge the mixing tube of any prior polymer present in the mixing tube, ensuring an accurate start concentration. Then the gradient would start pumping out, until the beginning of the gradient reached the nozzle 140. The excess polymer was collected in a scrap tray for removal. Once the excess polymer was removed, the gradient began to dispense out of the nozzle 140 and the build tray moved along until the entire slide was coated with polymer according to the specified gradient.

Characterizing Gradient

After the gradient was completed, it was placed in an oven at 50 degrees Celsius overnight for it to completely cure. A BioTek Synergy Ht plate reader was used to determine to absorbance of light at 557 nm. Fifteen discrete samples of polymer were created. The ratio of red and clear polymer was linear, with each discrete sample having one fifteenth more red than the previous. The discrete samples were plotted, with a linear best fit line plotted to the samples. Absorbance values were plotted as a function of composition along the gradient.

Macroscale Compression Test

A custom macroscale compression tester was used to measure the amount of deflection when a force was applied to the gradient. This was conducted at evenly spaced intervals along the slide. This deflection was then used to calculate the elastic modulus using Equation 1 in which E is the elastic modulus in MPa, v is the Poisson's ratio (0.49 for PDMS 8), w is the recorded displacement, q is the applied load density, i.e., stress, and a is the radius of the circular contact area under load. Each slide was placed on the base of the compression tester, and a 50-gram mass was used to apply force to the polymer. This was done on eleven evenly spaced locations along the length of the slide, and three locations across the width. This resulted in a total of 33 data points for each of the slides and four slides were used in this test.

$$E = \frac{2 * ( 1 - {v}^{2} ) * q * a}{w} \qquad ( Eq . 1 )$$

Polymer Composition Gradient Fabrication

The gradient fabrication system described herein can be used to deposit continuous gradients or other complex functions of varying properties. The programmed multi-pump system can deposit fluids with a wide range of compositions, densities or viscosities. For example, gradients in the crosslink density of a silicone elastomer can be dispensed and cured to create surface variation in stiffness as reported herein. To analyze and optimize this system, a mixture of pigment dyed and clear PDMS served as a quantifiable representation of variations in composition.

Initially, fifteen control PDMS samples of discrete mixtures were made from PDMS and PDMS with red pigment. Absorbance at 557 nm was recorded as a function of composition.

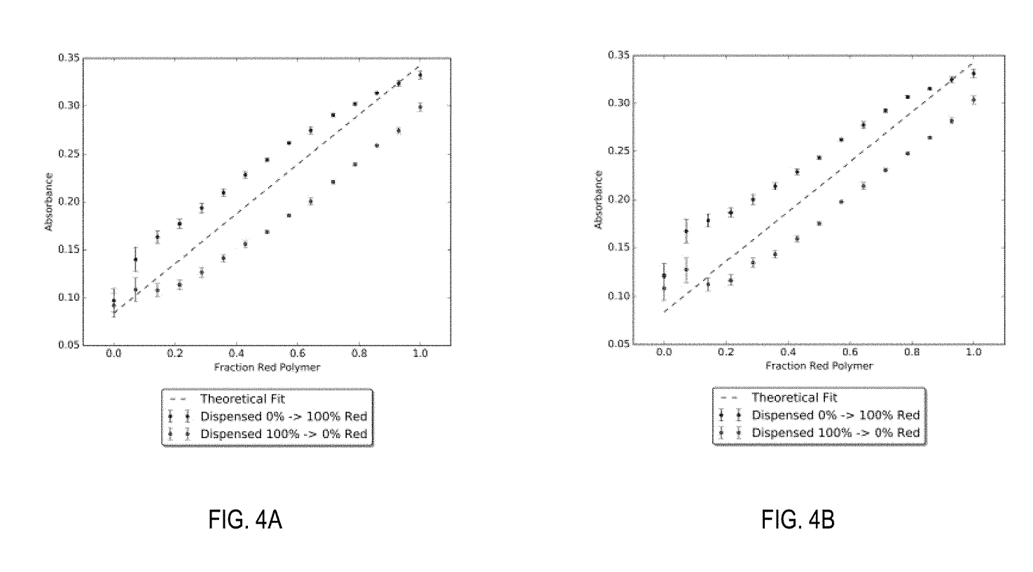

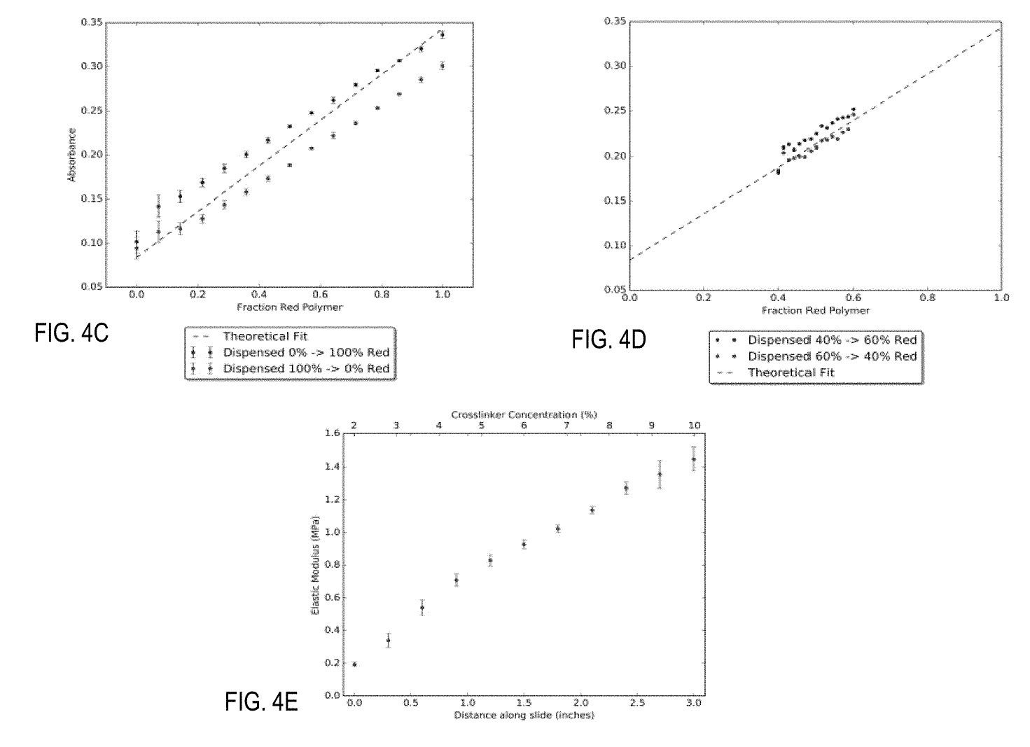

FIG. 4A is a plot of absorbance vs fraction red polymer along slide (1.8″ mixing tube, two mixers) where the number of samples used is six, according to some embodiments. Only the best fit line (R²=0.984) to the controls is shown for clarity. To determine the accuracy of the system, linear gradients were made that varied in composition. Using the best fit line previously mentioned, the samples were dispensed starting from 100% red to 0% red and starting from 0% red to 100% red. This allowed determination of how the error was dependent on the starting composition.

The initial tests were conducted using a two-inch-long mixing tube, and two separate static mixers placed sequentially after the y-connector. Comparing the absorbance of the gradient to the discrete samples indicated the successful creation of gradients; however, the compositions were shifted from the expected values (FIG. 4A). The lines had a different slope than the control and the absorbance shift depended on whether the dye concentration was increasing or decreasing. In both cases the accuracy was worse at the ending portion of the gradient. Upon analyzing the results from FIG. 4A, it appeared as if the center of the gradient was “shifted” to the left. The average error from each point to the theoretical value at that point was found to be 20.77%. The initial thought of this cause was when the polymers were mixing in the chamber that it was mixing along the length of the tube and not just along the width. This would cause the polymer that is behind to constantly mix with the polymer ahead, effectively diluting the mixture.

Effect of Number of Mixers and Tube Length on the Amount of Error

To determine if the proposed dilution was occurring, one of the mixers was removed, and the length of tubing was kept the same. FIG. 4B is a plot of absorbance vs fraction of red polymer along slide (3.8″ mixing tube, one mixer) where the number of samples used is six, according to some embodiments. As can be seen in FIG. 4B, the center of the gradient shows a similar shift, and the error was found to be 15.05%. This value is lower than the error found when using two mixers in the same size tube. This shows that the number of mixers does influence the amount of error present in the gradients. This is consistent with the dilution hypothesis posed.

To further determine the cause of the error, the next test conducted used only one mixer, and shortened the mixing tube to 0.75″. FIG. 4C is a plot of absorbance vs fraction red polymer along slide (1.8″ mixing tube, one mixer) where the number of samples used is six, according to some embodiments. As can be seen from FIG. 4C, the shift, while still present, is less pronounced. The error was found to be 11.77%, a further reduction from what was found with the longer mixing tube. This shows that the amount of error present is also dependent on the total length of the mixing tube chamber. Again, this is consistent with the dilution hypothesis.

Magnifying Narrower Ranges Decreases the Error

The amount of error was expected to decrease as the concentration range is decreased along the length of the gradient. FIG. 4D is a plot of absorbance vs fraction red polymer along the slide (3.8″ mixing tube, two mixers) where the number of samples used is two, according to some embodiments. In FIG. 4D, a gradient from 40% to 60% and 60% to 40% is shown. As can be seen visually, the error is smaller than any of the previous plots, and the actual error amounts to 4.60%.

Macroscale Testing

To create a PDMS gradient of varying stiffness, a ratio of base to curing agent of 10:1 was used in one dispensing device 110, and 50:1 in the other dispensing devices 110. The program was set to have the concentration of the dispensing devices start from 100% 10:1, finishing at 100% 50:1. This created a gradient in which the composition of the PDMS varied linearly across the length of the slide.

FIG. 4E is a plot of elastic modulus vs distance along slide, the number of samples used is four, according to some embodiments. As shown in FIG. 4E, when the elastic modulus is plotted against the distance along the slide, there is a clear linear relationship. Others conducted the same type of macroscale testing on discrete samples and found there to be a sinusoidal relationship. The samples that the others tested were 10:1 as the stiffest and 50:1 as the softest. The others was found that the 50:1 sample had an elastic modulus of 0.17 MPa. In the present gradient testing, it was found to be 0.176 MPa. For the 10:1 sample, the others found the modulus to be 1.75 MPa, in the present gradient testing, it was to be 1.554 MPa. When the gradients were printed, the stiffer 10:1 side was dispensed first. This appears to be the cause for the greatest variation on the stiff side. When the system characterized, the initial part dispensed had the greatest error, and it was expected to be softer at the start, as it was diluted.

TABLE 1
Selected Locations on Slide - Macroscale Results

| | | | | | | |
|---|---|---|---|---|---|---|
| Distance along slide (in) | 0 | 0.6 | 1.2 | 1.8 | 2.4 | 3 |
| Ratio Base:Curing Agent | 1 | 3 | 5 | 7 | 9 | 11 |
| Elastic Modulus (MPa) | 0.176 | 0.536 | 0.855 | 1.015 | 1.306 | 1.554 |
| Standard Deviation | 0.18 | 0.058 | 0.043 | 0.027 | 0.05 | 0.092 |

The resulting reduction in error found by “zooming in” the concentrations, allows this to be a very effective method in which to test varying properties of polymers. Given the results shown, another proposed method in which the accuracy would be increased is to make the physical length of the gradient longer. This should decrease the error to the same effect that reducing the concentrations variance does.

Accordingly, the disclosed systems and methods are operable to create polymer gradients in which any number of characteristics can be varied. The inaccuracies found have been characterized and methods in which to reduce them have been described. The gradients produced by these systems and methods can be used both as a test bed and in real world applications.

The methods and systems described herein can be utilized in many ways, including with a 3D printer. In one embodiment, instead of using syringe pumps to dispense materials that are mixed together, different 3D printer filaments can be mixed. This allows creation of a part that has multi-dimensional materials throughout. This is different than current 3D printing technology, and other technologies are not available to create such 3D gradient objects. In contrast most current 3D printed objects can be made by other automated methods. For example, 3D printers are commonly used in one of two ways, 1) to print a test part to verify attributes such a size and functionality of the part, for example, prior to having an injection mold made, and 2) to make scaled down parts for scaled down systems that are utilized for testing the systems. For example, scaled down racing cars with scaled down components are tested this way. However, both of these current 3D printing applications, while useful, are creating parts that can be made with traditional methods of manufacturing. The methods and systems described herein fabricate 3D gradient objects in a unique way, which provides an improvement over how 3D printers currently work.

Another application employs the methods and systems described herein with a bioprinter. Instead of us using a single type of cell and a single type of protein in a bio-print, multiple types of cells and multiple types of proteins may be utilized. Also, gradients of varying structural attributes or strengths may be printed. This allows for better replication of an organ, at least because a real organ has multiple types of proteins and/or multiple types of cells. Producing bio-prints with gradients provides an improvement towards printing a living human organ for transplantation into a patient.

The systems and methods corresponding to FIGS. 1-4E have been described as functional polymer gradients on surfaces in one and two dimensions. However, three dimensional applications based on the same principles provide improvements over current 3D printing systems. For, example, methods and systems described in FIGS. 1-4E may be utilized to produce 3D gradient objects with continuous material gradients extending in three dimensions instead of one or two. This 3D gradient process can create parts that current 3D printing processes or traditional fabrication method cannot achieve. Traditional 3D printers are used to create a quick test print, or a “one off” part. But those parts can be made with a different, more traditional method, typically faster and cheaper in larger quantities.

A 3D part or object may be fabricated having a 3D material gradient. In some embodiments, multiple materials may be utilized in different sections of a part, and the different materials may be joined gradually within the part, avoiding any stress concentrations or discrete interfaces that are normally created when joining dissimilar materials together. In this manner, a more spatially compact object can be created that can absorb force from a required impact while taking up the smallest amount of space or volume possible. Other applications include using gradients to accomplish the same goals of compliant mechanisms but retaining much more strength.

Functional gradients may be produced based on the system and methods described herein and using a 3D printer like head. This includes, but is not be limited to using polymers and inks as well as bioprinting. A bioprinter with gradient capability can produce gradients in matrix properties or composition, continuously varied cell concentrations and/or gel concentrations, and spatially regulated cell type mixtures. These gradient 3D printer systems produce a gradient that is mixed before the head of a print nozzle and dispense any type of substance or material. In general, the gradient systems described herein provide for a continuous mixing of component inks (materials) and a coupled dispensing of that continuously varied ink composition with spatial control by a gradient controller. Moreover, the gradients may occur in one, two or three dimensions.

Other 3D printers are different than the systems described herein, at least with respect to the filament used. Other 3D printers are used with thermoplastic polymers (e.g. PLA). The focus of those systems is to create parts with multiple colors, not different materials. Since those systems use thermoplastics, the mixing is done at the print head itself instead of being mixed prior to reaching the head of a print nozzle, and mixing is done using high heat. Using high heat, also limits the use to very similar materials that are mixed together.

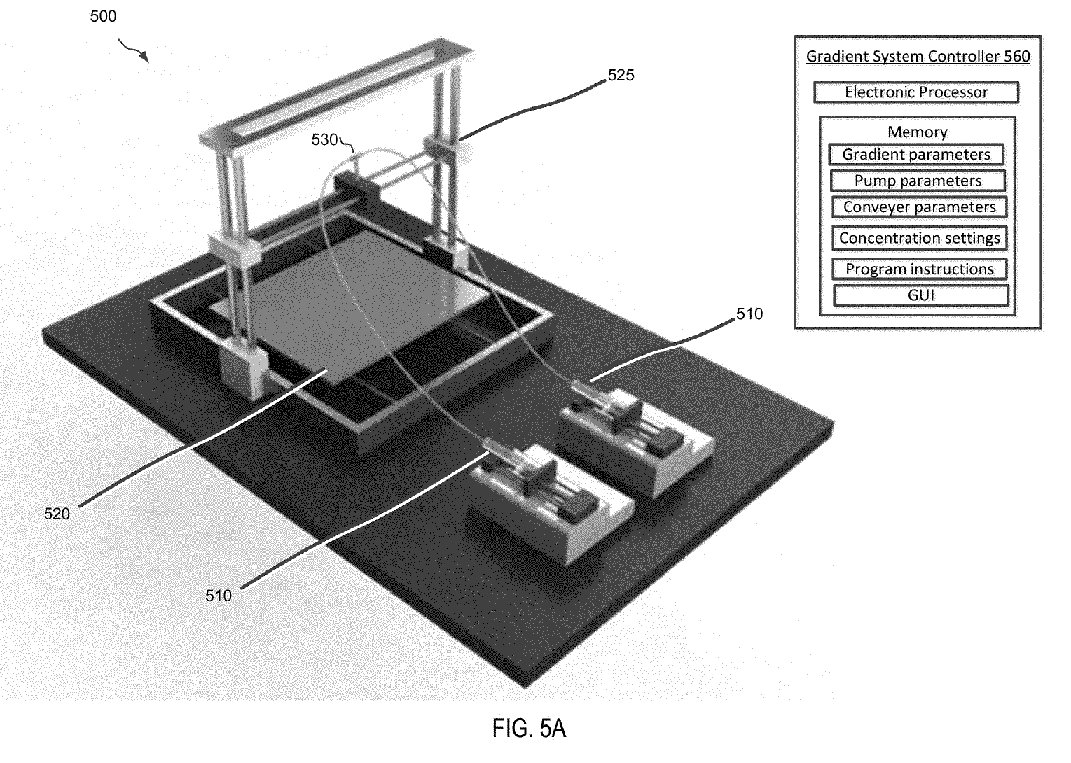

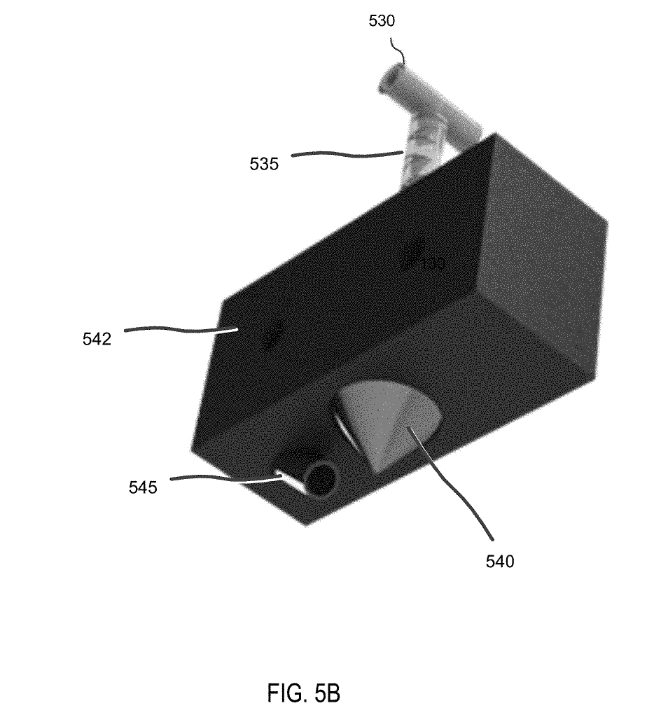

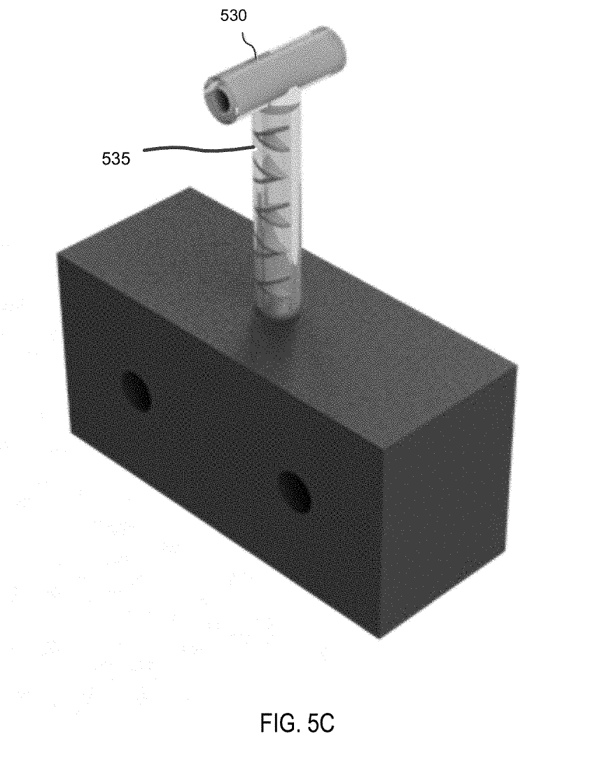

FIGS. 5A-5C illustrate a system for mixing materials to form an object having a gradient in composition and/or physical attributes, according to some embodiments. Referring to FIGS. 5A-5C, a system 500 includes multiple dispensing devices 510, an actuator collection bed 520 and a vertical structure 525. The actuator collection bed may be referred to as a collection bed or an actuator bed, for example. Although two dispensing devices are shown in FIG. 5A, the system 500 is not limited in this regard and may comprise additional dispensing devices 510. Furthermore, the disclosure is not limited to any specific type of dispensing device and any suitable dispensing device may be utilized, for example, a syringe pump, a commercially available dispensing device, a custom print head, or a forced extrusion mechanism of unique design. Outputs of each of the dispensing devices 510 are attached to a respective section of tubing. Each of the multiple sections of tubing are connected to one of a plurality of inputs of a connector 530 so that a material, for example, a polymer can flow from each the outputs of the multiple dispensing devices 510 into the plurality of inputs of the connector 530. The connector 530 is supported above the actuator collection bed 520 by the vertical structure 525. A single piece of tubing forms a mixing tube 535 (see detail in FIGS. 5B-5C), which is connected to a single output of the connector 530. One or more mixers are disposed inside the length of the mixing tube 535 (see FIG. 5C for detail). The mixers may comprise a standard “static” mixer that fits inside the flexible plastic tubing. Alternatively other types of mixers may be utilized. For example, a “dynamic” mixer may be used that includes a separately powered propeller to mix incoming polymers into a homogenous mixture. An output end of the mixing tube 535 is further attached to an extruder head two comprising a dispensing nozzle 540 (see FIG. 5B). The end of the dispensing nozzle 540 may be disposed above the actuator collection bed 520. The actuator collection bed 520 is mobilized by a motor (not shown) for carriage in one, two or three dimensions for one, two, or three dimensional printing depending on the design of a particular system. The vertical structure 525 supports the extruder head 542, the dispensing nozzle 540, the UV light 545, the mixing tube 535, and the connector 530. In some embodiments, elements of the vertical structure 525 may be mobilized by a motor and may be configured to raise or lower the extruder head 542 and thus the dispensing nozzle 540, and the UV light 545, for example, for deposition of a varying mixture of materials in three dimensional gradient printing, depending on a particular design of the system.

A gradient system controller 560 is communicatively coupled to each of the multiple dispensing devices 510 and to one or more motors (not shown) for mobilizing or driving the collection bed of the actuator 520. In some embodiments, the one or more motors may drive movement of an element on the vertical structure 525, for example, the extruder head 542 that supports the dispensing nozzle 540. The gradient controller 560 comprises an electronic processor and memory. The memory stores program instructions that cause the electronic processor to send commands to the multiple dispensing devices 510 to dispense a fluid material, for example, polymer, ink, or gel from the plurality of dispensing devices to form a output comprising one or more gradients. The program instructions provide constant ratio or complex function inputs to control time-dependent dispensing device dispense rates for each of the multiple dispensing devices 510 for creating a specified gradient. The program instructions further cause the electronic processor to send commands to mobilize the actuator collection bed 520 to move the bed at a specified speed and/or a specified direction such that the dispensing nozzle 540 dispenses the specified gradient on the actuator collection bed 525, or on a slide or tray disposed thereon. The program instructions may control the deposition of a changing mixture of materials in one, two or three dimensional gradient printing, depending on a particular design of the system. In other words, in some embodiments, the actuator collection bed 520 is moveable relative to the dispensing nozzle 540, and gradient controller 560 controls movement of the collection bed 520 while the dispensing nozzle 540 dispenses the continuously varying mixture of materials to form the gradient product comprising the varied composition of matter. Also, in some embodiments, the dispensing nozzle 540 is movable relative to the collection bed 520 and the electronic processor controls movement of the dispensing nozzle 540. Furthermore, in some embodiments, the collection bed 520 and the dispensing nozzle 540 are both movable, and the electronic processor 560 controls a combination of movements of the collection bed and the dispensing nozzle while the dispensing nozzle 540 dispenses the continuously varying mixture of materials to form the gradient product comprising the varied composition of matter. The collection bed 520 may move in one, two, or three dimensions, and/or the dispensing nozzle may move in one, two, or three dimensions.

The system 100 may physically mix multiple different polymer samples output by the multiple dispensing devices 510 and then dispense the mixture onto the actuator bed 525 (or build tray) disposed on the actuator bed 520, via the nozzle 540. The polymers may be crosslinked by the UV light 545. This system and method makes it possible to vary any property that is affected by changing material compositions that are mixed in the mixing tube 535. This system may also be used for bio-printing.

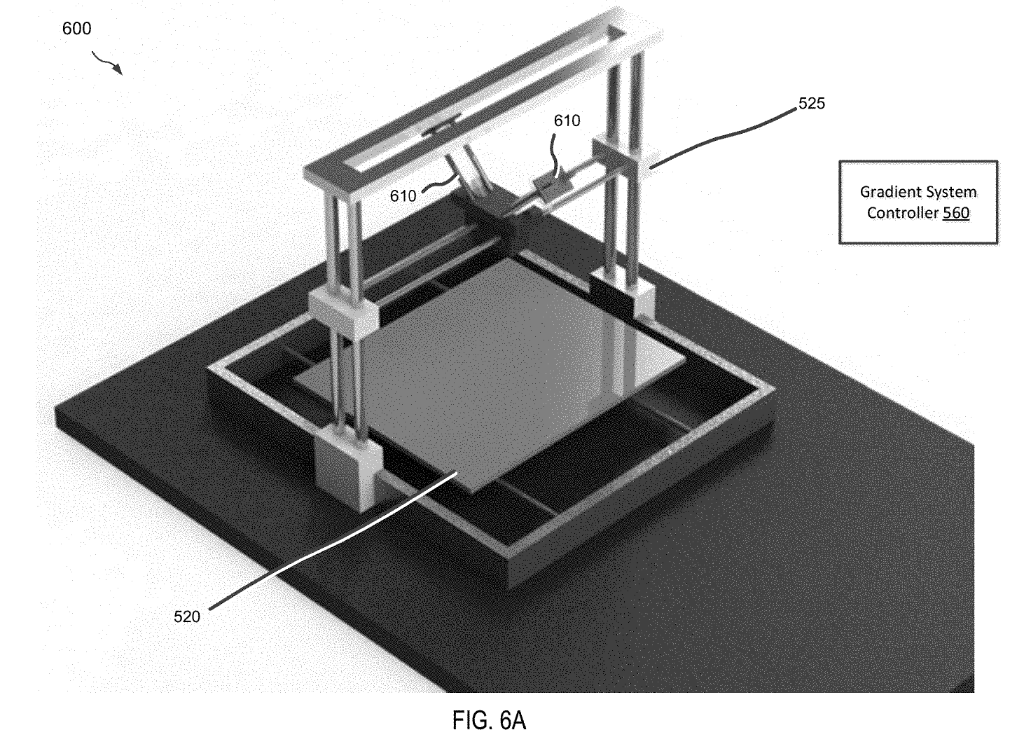

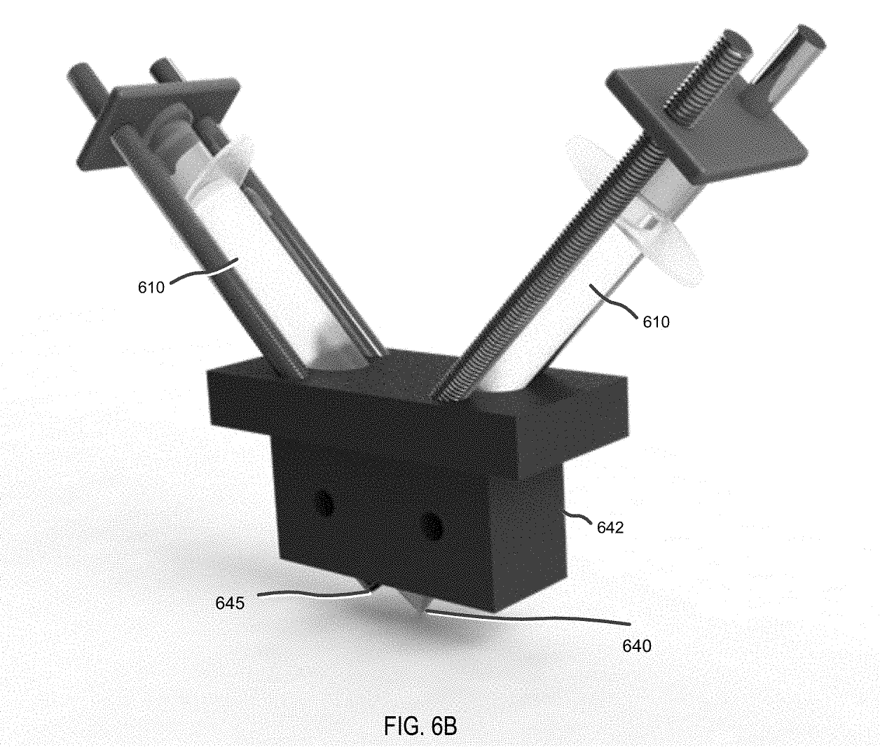

FIGS. 6A-6B illustrate a system for mixing materials to form an object having a gradient in composition and/or physical attributes, according to some embodiments. Referring to FIGS. 6A-6B, a system 600 includes some of the features described with respect to FIGS. 5A-5C, for example, the system 600 includes the actuator bed 520, the vertical structure 525 and the gradient system controller 560 that are configured and operate as described above. However, instead of having the dispensing devices controlled externally to an extruder head, the system 600 includes multiple dispensing devices 610 that are connected directly on an extruder head 642. The multiple dispensing devices 610 are controlled by a linear actuator within the extruder head 642. With this configuration, the mixing of the input materials can be done as described with respect to FIGS. 1-5C, with a “static” mixer within the head, or using a “dynamic” mixer, as previously described.

With any of the gradient systems described above, any of multiple different types of inks or polymers can be used, with different methods of “curing.” The method of curing described above uses a type of photopolymer that is cured immediately after dispensing the gradient material, with a high intensity UV light. A different type of curing that can be used is to have a polymer, such as a thermoplastic, dissolved into a suitable solvent. This viscous mixture will then be cured by driving off the solvent, which can be achieved either through use of a fan or a heated fan.

What is claimed is:

1. A system for mixing component materials and dispensing a gradient product comprising a continuously varied composition of matter, the system comprising:
multiple dispensing devices actuated by a motor,
a connector comprising multiple inputs, wherein each of the multiple connector inputs receives component material from a respective one of the multiple dispensing devices;
a mixing tube connected to an output of the connector, wherein the mixing tube receives the component material from each of the multiple dispensing devices and mixes the component material;
a dispensing nozzle connected to the mixing tube wherein the dispensing nozzle receives a continuously varying mixture of materials from the mixing tube and dispenses the continuously varying mixture of materials to form a gradient product comprising a continuously varying composition of matter;
a collection bed that receives the gradient product, and
an electronic processor coupled to a memory comprising instructions that when executed by the electronic processor causes the electronic processor to spatially control the varied composition of matter of the gradient product.

2. The system of claim 1 wherein the electronic processor controls the multiple dispensing devices by controlling a motor that drives the dispensing devices for delivering the component material to the connector inputs.

3. The system of claim 1, wherein:
the collection bed for receiving the gradient product is an actuator bed that moves relative to the dispensing nozzle; and
the electronic processor controls movement of the collection bed while the dispensing nozzle dispenses the continuously varying mixture of materials to form the gradient product comprising the varied composition of matter.

4. The system of claim 1, wherein the electronic processor provides time-dependent dispensing device dispense rates for each of the multiple dispensing devices and coordinates movement of the collection bed with the dispense rates for creating a specified gradient in the gradient product.

5. The system of claim 1, wherein gradient product is one of:
a gradient product comprising matrix properties or composition, continuously varied cell concentrations, continuously varied gel concentrations, or spatially regulated cell type mixtures; or
a three dimensional gradient product.

6. The system of claim 1, wherein:
the multiple dispensing devices are located remotely from the connector inputs and an input tube is connected from each of the multiple dispensing devices to a respective input of the connector for delivering the component material to the connector; or
the multiple dispensing devices and the connector are locally supported by an extruder head and the connector receives the component material directly from the multiple dispensing devices.

7. The system of claim 1, wherein gradient product comprising a continuously varying composition of matter continuously varies between softer compositions of matter to stiffer compositions of matter.

8. The system of claim 1, further comprising a graphical user interface for receiving system configuration and material concentration parameters that are utilized in determining the instructions for controlling the varied composition of matter of the gradient product.

9. The system of claim 1, wherein the component material is uniquely specified for each of the multiple dispensing devices.

10. The system of claim 9, wherein the component material uniquely specified for each of the multiple dispensing devices comprises a polymer of a uniquely specified concentration.

11. The system of claim 1, wherein:
the dispensing nozzle is movable relative to the collection bed; and
the electronic processor controls movement of the dispensing nozzle while the dispensing nozzle dispenses the continuously varying mixture of materials to form the gradient product comprising the varied composition of matter.

12. The system of claim 1, wherein:
the collection bed and the dispensing nozzle are movable; and
the electronic processor controls a combination of movements of the collection bed and the dispensing nozzle while the dispensing nozzle dispenses the continuously varying mixture of materials to form the gradient product comprising the varied composition of matter.

13. A method for mixing component materials and dispensing a gradient product comprising a continuously varied composition of matter, the method comprising:
delivering, by multiple dispensing devices that are actuated by a motor, component material to a connector comprising multiple inputs, wherein each of the multiple connector inputs receives the component material from a respective one of the multiple dispensing devices;
forwarding the component material to a mixing tube connected to a single output of the connector, wherein the mixing tube receives the component material from each of the multiple dispensing devices via the connector and mixes the component material;
receiving, by a dispensing nozzle connected to the mixing tube, a continuously varying mixture of materials from the mixing tube and dispensing the continuously varying mixture of materials onto a collection bed to form a gradient product comprising a continuously varying composition of matter; and
spatially controlling, by an electronic processor connected to a memory, the varied composition of matter of the gradient product.

14. The method of claim 13, wherein the electronic processor controls the multiple dispensing devices by controlling a motor that drives the dispensing devices for delivering the component material to the connector inputs.

15. The method of claim 13, wherein:
the collection bed for receiving the gradient product is an actuator bed that moves relative to the dispensing nozzle; and
the electronic processor controls movement of the collection bed while the dispensing nozzle dispenses the continuously varying mixture of materials to form the gradient product comprising the varied composition of matter.

16. The method of claim 13, wherein the electronic processor provides time-dependent dispensing device dispense rates for each of the multiple dispensing devices and coordinates movement of the collection bed with the dispense rates for creating a specified gradient in the gradient product.

17. The method of claim 13, wherein the gradient product is one of:
a gradient product comprising matrix properties or composition, continuously varied cell concentrations, continuously varied gel concentrations, or spatially regulated cell type mixtures; or
a three dimensional gradient product.

18. The method of claim 13, wherein:
the multiple dispensing devices are located remotely from the connector inputs and an input tube is connected from each of the multiple dispensing devices to a respective input of the connector for delivering the component material to the connector; or
the multiple dispensing devices and the connector are locally supported by an extruder head and the connector receives the component material directly from the multiple dispensing devices.

18. The method of claim 13, wherein gradient product comprising a continuously varying composition of matter continuously varies between softer compositions of matter to stiffer compositions of matter.

20. The method of claim 13 further comprising, receiving by a graphical user interface system configuration and material concentration parameters that are utilized in determining the instructions for controlling the varied composition of matter of the gradient product.

21. The method of claim 13, wherein the component material is uniquely specified for each of the multiple dispensing devices.

22. The method of claim 9, wherein the component material uniquely specified for each of the multiple dispensing devices comprises a polymer of a uniquely specified concentration.

23. The method of claim 13, wherein:
the dispensing nozzle is movable relative to the collection bed; and
the electronic processor controls movement of the dispensing nozzle while the dispensing nozzle dispenses the continuously varying mixture of materials to form the gradient product comprising the varied composition of matter.

24. The method of claim 13, wherein:
the collection bed and the dispensing nozzle are movable; and
the electronic processor controls a combination of movements of the collection bed and the dispensing nozzle while the dispensing nozzle dispenses the continuously varying mixture of materials to form the gradient product comprising the varied composition of matter.
